(19) United States
(12) Patent Application Publication
(10) Pub. No.: US 2022/0108104 A1
(43) Pub. Date: Apr. 7, 2022

(54) METHOD FOR RECOGNIZING RECOGNITION TARGET PERSON

(71) Applicant: HONDA MOTOR CO., LTD., Tokyo (JP)

(72) Inventors: Zijun Sha, Saitama (JP); Yoichi Natori, Saitama (JP); Takahiro Ariizumi, Saitama (JP)

(21) Appl. No.: 17/489,139

(22) Filed: Sep. 29, 2021

(30) Foreign Application Priority Data
Oct. 2, 2020 (JP) 2020-167911

(51) Int. Cl. G06K 9/00; G06T 7/73

(52) U.S. Cl. CPC G06K 9/00288; G06T 7/74; G06K 9/00342

(57) ABSTRACT

A control device 10 of a robot 2 includes a facial recognition tracking unit 32, a human body tracking unit 33, a person re-identification unit 35, and a determination unit 37. The facial recognition tracking unit 32 executes facial recognition processing and face tracking processing, the human body tracking unit 33 executes human body tracking processing, and the person re-identification unit 35 executes person re-identification processing. Furthermore, when at least one of the facial recognition processing, the film tracking processing, the human body tracking processing, and the person re-identification processing is successful, a determination unit 36 determines that a recognition target person is successfully identified.

### BACKGROUND

### Technical Field

The present invention relates to a method for recognizing a recognition target person following a mobile device.

### Related Art

Conventionally, a guide robot described in JP 2003-340764 A is known. The guide robot guides a guide target person to a destination while causing the guide target person to follow the robot, and includes a camera and the like. In the case of the guide robot, when guiding a guide target person, the guide target person is recognized by a recognition method described below. That is, a recognition display tool is put on the guide target person, an image of the guide target person is captured by a camera, and the recognition display tool in the image is detected. Thus, the guide target person is recognized.

### SUMMARY

According to a recognition method of JP 2003-340764 A described above, since it is a method including detecting a recognition display tool in an image captured by a camera when recognizing a guide target person, it is difficult to continuously recognize the guide target person when surrounding environment of the guide target person changes. For example, when another pedestrian, an object, or the like is interposed between the guide robot and the guide target person, and the guide target person is not shown in the image of the camera, recognition of the guide target person fails.

In addition, in a case where brightness around the guide target person changes or a posture of the guide target person changes, even when the guide target person is shown in the image of the camera, the recognition display tool in the image cannot be detected, and there is a possibility that the recognition of the guide target person fails. The above problems also occur when a mobile device other than the guide robot is used.

The present invention has been made to solve the above problems, and it is an object of the present invention to provide a method for recognizing a recognition target person, capable of increasing a success frequency in recognition when recognizing a recognition target person following a mobile device and of continuously recognizing the recognition target person for a longer time.

In order to achieve the above object, an invention according to claim 1 is a method for recognizing a recognition target person that follows a mobile device including an imaging device, a recognition device, and a storage device when the mobile device moves, by the recognition device, based on a spatial image captured by the imaging device, the method executed by the recognition device, including: a first step of storing a face image of the recognition target person in the storage device as a reference face image; a second step of acquiring the spatial image captured by the imaging device; a third step of storing a reference person image, which is an image for reference of the recognition target person, in the storage device; a fourth step of executing at least three types of processing among facial recognition processing for recognizing a face of the recognition target person in the spatial image based on the reference face image and the spatial image, face tracking processing for tracking the face of the recognition target person based on the spatial image, human body tracking processing for tracking a human body of the recognition target person based on the spatial image, and person re-identification processing for recognizing the recognition target person in the spatial image based on the spatial image and the reference person image; and a fifth step of determining that the recognition of the recognition target person is successful when at least one of the at least three types of processing executed in the fourth step is successful.

According to the method for recognizing a recognition target person, in the fourth step, at least three types of processing among the facial recognition processing for recognizing the face of the recognition target person in the spatial image based on the reference face image and the spatial image, the face tracking processing for tracking the face of the recognition target person based on the spatial image, the human body tracking processing for tracking the human body of the recognition target person based on the spatial image, and the person re-identification processing for recognizing the recognition target person in the spatial image based on the spatial image and the reference person image are executed. Then, in the fifth step, when at least one of the at least three types of processing executed in the fourth step is successful, it is determined that the recognition of the recognition target person is successful. As described above, in a case where at least three type of processing among the facial recognition processing, the face tracking processing, the human body tracking processing, and the person re-identification processing are executed, when at least one of the three types of processing is successful, the recognition target person can be recognized. Therefore, even when the surrounding environment of the recognition target person changes, the success frequency in recognition of the recognition target person can be increased. As a result, it is possible to continuously recognize the recognition target person for a longer time as compared to conventional methods.

An invention according to claim 2 is the method for recognizing a recognition target person according to claim wherein in the execution of the fourth step, when all of the facial recognition processing, the face tracking processing, and the human body tracking processing fail and the person re-identification processing is successful at least one of next facial recognition processing face tracking processing, and human body tracking processing is executed using the successful result in the person re-identification processing, and in the execution of the fourth step, when the person re-identification processing fails and the human body tracking processing is successful, next person re-identification processing is executed using the successful result in the human body tracking processing.

According to this method for recognizing a recognition target person, in the execution of the fourth step, when all of the facial recognition processing, the face tracking processing, and the human body tracking processing fail and the person re-identification processing is successful, at least one of the next facial recognition processing, face tracking processing, and human body tracking processing is executed using the successful result in the person re-identification processing. Accordingly, in the execution of the next facial recognition processing face tracking processing, and human body tracking processing are executed, even when at least one of previous facial recognition processing, face tracking processing, and human body tracking processing fail, at least one type of processing can be executed in a state identical to a state of a previous success.

On the other hand, in the execution of the fourth step, when the person re-identification processing fails and the human body tracking processing is successful, the next person re-identification processing is executed using the successful result of the human body tracking processing. Accordingly, when the next person re-identification processing is executed, probability of success in the person re-identification processing can be increased. As described above, the success frequency in recognition of the recognition target person can be further increased.

An invention according to claim 3 is the method for recognizing a recognition target person according to claim 1 or 2, wherein in the third step, an image of a human body in the case of the successful human body tracking processing is compared with the reference person image stored in the storage device, and when a degree of difference between the image of the human body and the reference person image is larger than a predetermined value, the image of the human body is additionally stored in the storage device as another reference person image.

According to the method for recognizing a recognition target person, in the third step, when the degree of difference between the image of the human body in the case of the successful human body tracking processing and the reference person image stored in the storage device is larger than the predetermined value, an image in a human body bounding box is additionally stored in the storage device as another reference person image. Therefore, when the person re-identification processing in the next or subsequent fourth step is executed, there are more variations and the number of the reference person images to be used, and accordingly, the success frequency in person re-identification processing can be further increased. Note that the degree of difference between the image of the human body and the reference person image herein includes the degree of difference between a feature amount of the image of the human body and a feature amount of the reference person image.

### BRIEF DESCRIPTION OF DRAWINGS

FIG. 1 is a view illustrating an appearance of a robot to which a method for recognizing a recognition target person according to an embodiment of the present invention is applied;

FIG. 2 is a view illustrating a configuration of a guidance system;

FIG. 3 is a block diagram illustrating an electrical configuration of a robot;

FIG. 4 is a block diagram illustrating a functional configuration of a control device;

FIG. 5 is a flowchart illustrating facial recognition tracking processing;

FIG. 6 is a view illustrating a guide target person, a face bounding box, and a human body bounding box in a rear spatial image;

FIG. 7 is a flowchart illustrating human body tracking processing;

FIG. 8 is a flowchart illustrating person re-identification processing; and

FIG. 9 is a flowchart illustrating result determination processing.

### DETAILED DESCRIPTION

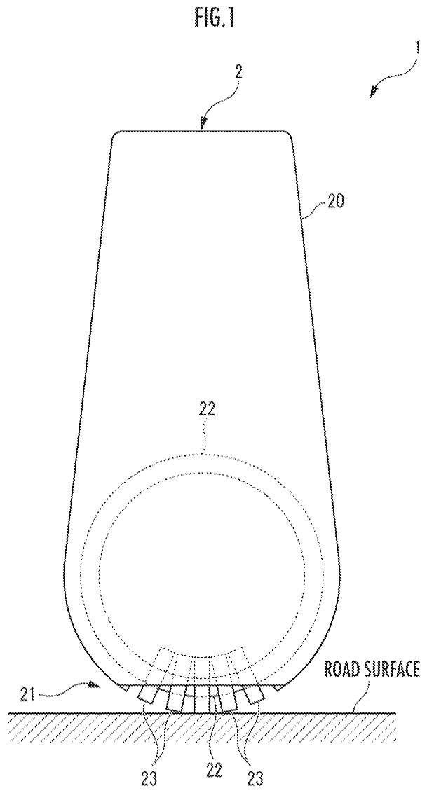

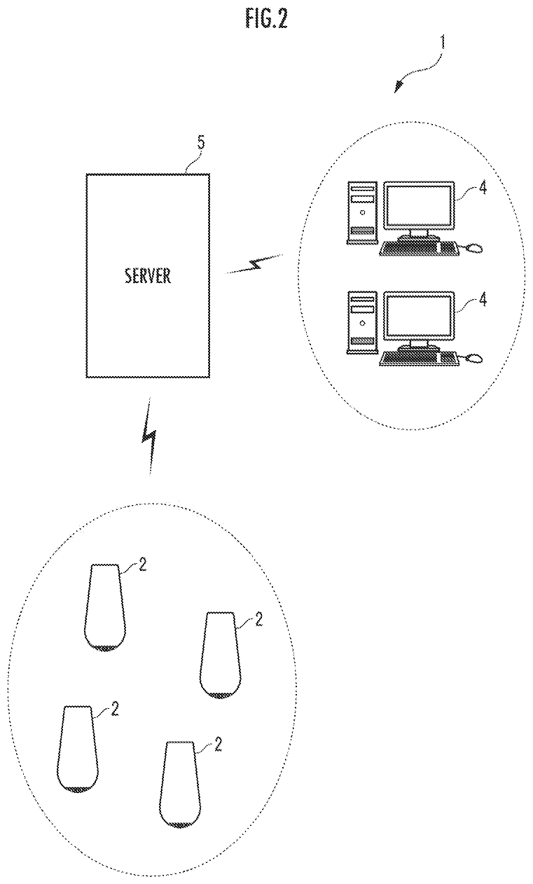

Hereinafter, a method for recognizing a recognition target person according to an embodiment of the present invention will be described. The recognition method of the present embodiment is used when an autonomous mobile robot 2 guides a guide target person as a recognition target person to a destination, in a guidance system 1 illustrated in FIGS. 1 and 2.

The guidance system 1 is of a type in which, in a shopping mall, an airport, or the like, the robot 2 guides a guide target person to the destination (for example, a store or a boarding gate) while leading the guide target person.

As illustrated in FIG. 2, the guidance system 1 includes a plurality of robots 2 that autonomously moves in a predetermined region, an input device 4 provided separately from the robots 2, and a server 5 capable of wirelessly communicating with the robots 2 and the input device 4.

The input device 4 is of a personal computer type, and includes a mouse, a keyboard, and a camera (not illustrated). In the input device 4, a destination of a guide target person is input by the guide target person (or operator) through mouse and keyboard operations, and a robot 2 (hereinafter referred to as “guide robot 2”) that guides the guide target person is determined from among the robots 2.

Furthermore, in the input device 4, a face of the guide target person captured by a camera (not illustrated), and the captured face image is registered in the input device 4 as a reference face image. In the input device 4, as described above, after the destination of the guide target person is input, the guide robot 2 is determined, and the reference face image is registered, a guidance information signal including these pieces of data is transmitted to the server 5.

When receiving the guidance information signal from the input device 4, the server 5 sets, as a guidance destination, the destination itself of the guide target person or a relay point to the destination based on internal map data. Then, the server 5 transmits the guidance destination signal including the guidance destination and a reference face image signal including the reference face image to the guide robot 2.

Next, a mechanical configuration of the robot 2 will be described. As illustrated in FIG. 1, the robot 2 includes a main body 20, a moving mechanism 21 provided in a lower portion of the main body 20, and the like, and is configured to be movable in all directions on a road surface with use of the moving mechanism 21.

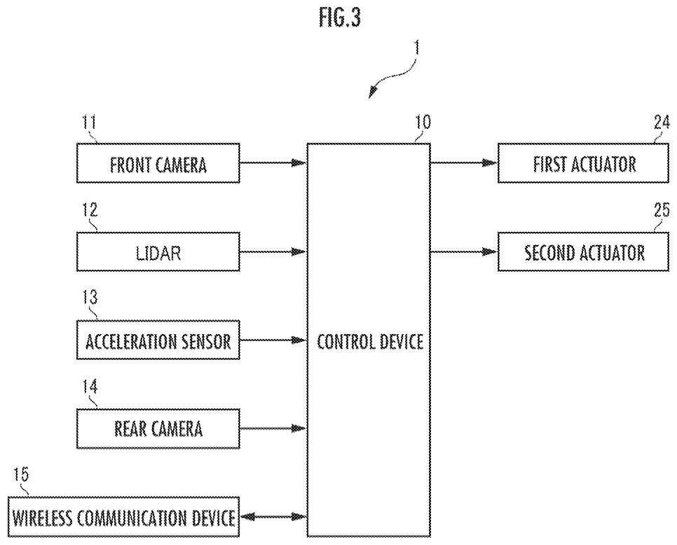

Specifically, the moving mechanism 21 is similar to, for example, that of JP 2017-56763 and, thus, detailed description thereof will not he repeated here. The moving mechanism 21 includes an annular core body 22, a plurality of rollers 23, a first actuator 24 (see FIG. 3), a second actuator 25 (see FIG. 3), and the like.

The rollers 23 are extrapolated to the core body 22 so as to be arranged at equal angular intervals in a circumferential direction (around an axis) of the core body 22, and each of the rollers 23 is rotatable integrally with the core body 22 around the axis of the core body 22. Each roller 23 is rotatable around a central axis of a cross section of the core body 22 (an axis in a tangential direction of a circumference centered on the axis of the core body 22) at an arrangement position of each roller 23.

Furthermore, the first actuator 24 includes an electric motor, and is controlled by a control device 10 as described later, thereby rotationally driving the core body 22 around the axis thereof via a drive mechanism (not illustrated).

On the other hand, similarly to the first actuator 24 the second actuator 25 also includes an electric motor. When a control input signal is input from the control device 10, the roller 23 is rotationally driven around the axis thereof via a drive mechanism (not illustrated). Accordingly, the main body 20 is driven by the first actuator 24 and the second actuator 25 so as to move in all directions on the road surface. With the above configuration, the robot 2 can move in all directions on the road surface.

Next, an electrical configuration of the robot 2 will be described. As illustrated in FIG. 3, the robot 2 further includes the control device 10, a front camera 11, a LIDAR 12, an acceleration sensor 13, a rear camera 14, and a wireless communication device 15. The wireless communication device 15 is electrically connected to the control device 10, and the control device 10 executes wireless communication with the server 5 via the wireless communication device 15.

The control device 10 includes a microcomputer including a CPU, a RAM, a ROM, an E2PROM, an I/O interface, various electric circuits (all not illustrated), and the like. In the E2PROM, map data of a place guided by the robot 2 is stored. When the wireless communication device 15 described above receives the reference face image signal, the reference face image included in the reference face image signal is stored in the E2PROM. In the present embodiment, the control device 10 corresponds to a recognition device and a storage device.

The front camera 11 captures an image of a space in front of the robot 2 and outputs a front spatial image signal indicating the image to the control device 10. In addition, the LIDAR 12 measures, for example, a distance to an object in the surrounding environment using laser light, and outputs a measurement signal indicating the distance to the control device 10.

Further, the acceleration sensor 13 detects acceleration of the robot 2 and outputs a detection signal representing the acceleration to the control device 10. The rear camera 14 captures an image of a peripheral space behind the robot 2, and outputs a rear spatial image signal representing the image to the control device 10. Note that, in the present embodiment, the rear camera 14 corresponds to an imaging device.

The control device 10 estimates a self-position of the robot 2 by an adaptive Monte Carlo localization (amlc) method using the front spatial image signal of the front camera and the measurement signal of the LIDAR 12, and calculates speed of the robot 2 based on the measurement signal of the LIDAR 12 and the detection signal of the acceleration sensor 13.

In addition, when receiving the guidance destination signal from the server 5 via the wireless communication device 15, the control device 10 reads a destination included in the guidance destination signal and determines a movement trajectory to the destination. Further, when receiving the rear spatial image signal from the rear camera 14 via the wireless communication device 15, the control device 10 executes each processing for recognizing the guide target person as described later.

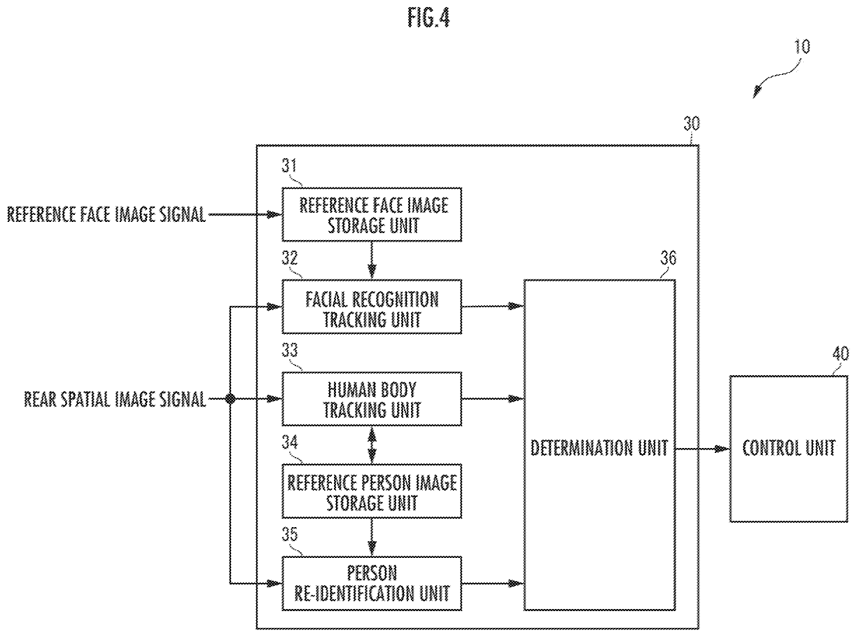

Next, the method for recognizing a guide target person by the control device 10 of the present embodiment will be described. As illustrated in FIG. 4, the control device 10 includes a recognition unit 30 and a control unit 40. The recognition unit 30 recognizes the guide target person following the guide robot 2 by the following method. In the following description, a case where there is one guide target person will be described, as an example.

As illustrated in FIG. 4, the recognition unit 30 includes a reference face image storage unit 31, a facial recognition tracking unit 32, a human body tracking unit 33, a reference person image storage unit 34, a person re-identification unit 35, and a determination unit 36.

In the reference face image storage unit 31, when the control device 10 receives the reference face image signal, the reference face image included in the reference face image signal is stored in the reference face image storage unit 31.

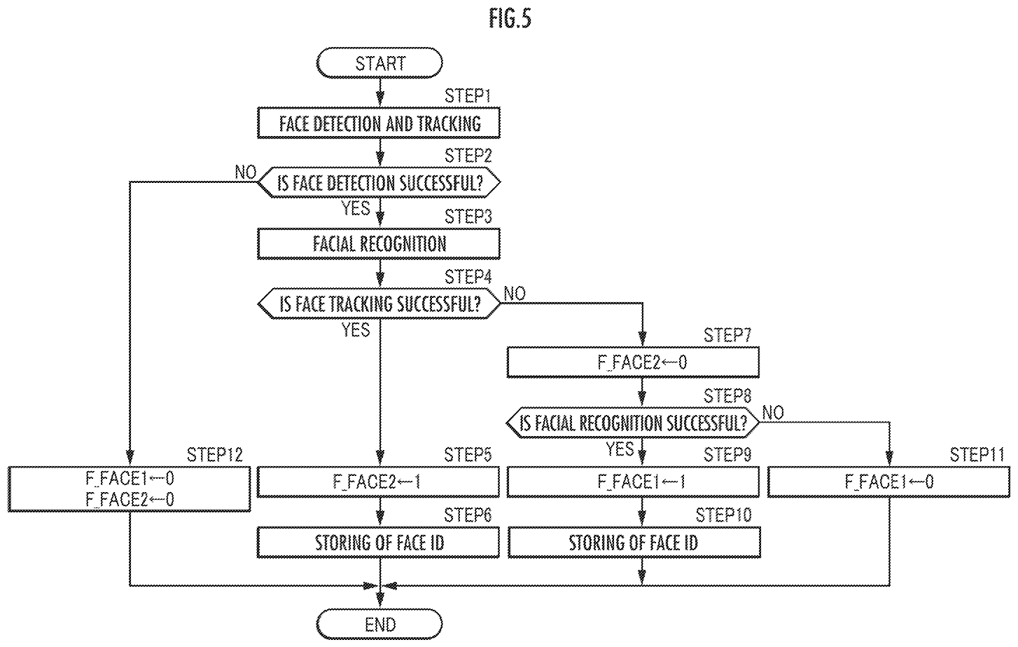

Furthermore, in the facial recognition tracking unit 32, when the rear spatial image signal describe above is input from the rear camera 14 to the control device 10, facial recognition tracking processing is executed as illustrated in FIG. 5. In the facial recognition tracking processing, facial recognition and face tracking of the guide target person are executed as described below using the rear spatial image included in the rear spatial image signal and the reference face image in the reference face image storage unit 31.

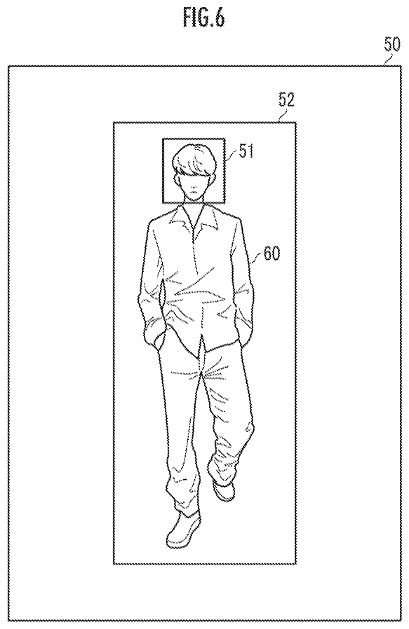

As illustrated in the figure, first, face detection and tracking processing is executed (FIG. 5/STEP1). In the face detection and tracking processing, face detection is executed first. Specifically, when as guide target person 60 is present in a rear spatial image 50 as illustrated in FIG. 6, a face image is detected in the rear spatial image 50. In this case, the face in the rear spatial image 50 is detected using a predetermined image recognition method (for example, an image recognition method using a convolutional neural network (CNN)). When the face detection is successful, a provisional face ID is assigned to a face bounding box 51 as illustrated in FIG. 6.

Following the face detection, the face tracking of the guide target person is executed. Specifically, for example, the face tracking is executed based on a relationship between a position of the face bounding box 51 (see FIG. 6) at previous detection and a position of the face bounding box 51 at current detection, and when the relationship between both of the positions is in a predetermined state, it is recognized that the face tracking of the guide target person is successful. Then, when the face tracking of the guide target person is successful, the provisional face ID is abandoned, and a face ID of the guide target person stored in the facial recognition tracking unit 32 is set as a current face ID of the guide target person. That is, the face ID of the guide target person is maintained.

Next, it is determined whether the face detection is successful (FIG. 5/STEP2). When the determination is negative (FIG. 5/STEP2 . . . NO) and the face detection fails, both a facial recognition flag F_FACE1 and a face tracking flag F_FACE2 are set to “0” to represent that both the facial recognition and the face tracking fail (FIG. 5/STEP12). Thereafter, this processing ends.

On the other hand, when the determination is affirmative (FIG. 5/STEP2 . . . YES) and the face detection is successful, the facial recognition processing is executed (FIG. 5/STEP3). The facial recognition processing is executed using the predetermined image recognition method (for example, an image recognition method using the CNN).

Next, in the face detection and tracking processing, it is determined whether the face tracking of the guide target person is successful (FIG. 5/STEP4). When the determination is affirmative (FIG. 5/STEP4 . . . YES) and the face tracking of the guide target person is successful, the face tracking flag F_FACE2 is set to “1” to represent the success (FIG. 5/STEP5).

Next, processing of storing the face ID is executed (FIG. 5/STEP6). Specifically, the face ID of the guide target person maintained in the above face detection and tracking processing is stored in the facial recognition tracking unit 32 as the face ID of the guide target person. Thereafter, this processing ends.

On the other hand, when the determination is negative (FIG. 5/STEP4 . . . NO) and the face tracking of the guide target person fails, the face tracking flag F_FACE2 is set to “0” to represent the failure (FIG. 5/STEP7).

Next, it is determined whether the facial recognition of the guide target person is successful (FIG. 5/STEP8). In this case, when a degree of similarity between feature amounts of the face image and the reference face image calculated in the facial recognition processing is a predetermined value or larger, it is determined that the facial recognition of the guide target person is successful, and when the degree of similarity between the feature amounts is less than the predetermined value, it is determined that the facial recognition of the guide target person fails.

When the determination is affirmative (FIG. 5/STEP8 . . . YES) and the facial recognition of the guide target person is successful, the facial recognition flag F_FACE1 is set to “1” to represent the success (FIG. 5/STEP9).

Next, processing of storing the face ID is executed (FIG. 5/STEP10). Specifically, the provisional face ID assigned to the face bounding box when the face detection is successful is stored in the facial recognition tracking unit 32 as the face ID of the guide target person. Thereafter, this processing ends.

On the other hand, when the determination is negative (FIG. 5/STEP8 . . . NO) and the facial recognition of the guide target person fails, the facial recognition flag F_FACE1 is set to “0” to represent the failure (FIG. 5/STEP11). Thereafter, this processing ends.

As described above, in the facial recognition tracking unit 32, the facial recognition and the face tracking of the guide target person are executed, so that values of the two flags F_FACE1 and F_FACE2 are set. Then, these two flags F_FACE1 and F_FACE2 are output from the facial recognition tracking unit 32 to the determination unit 36. At the same time, although not illustrated, these two flags F_FACE1 and F_FACE2 are output from the facial recognition tracking unit 32 to the human body tracking unit 33.

Note that, although both the facial recognition processing and the face tracking processing are simultaneously executed in the facial recognition tracking unit 32, the facial recognition processing and the thee tracking processing may be separately executed independently of each other. That is, the facial recognition processing and the face tracking processing may be executed in parallel.

Furthermore, in the case of the facial recognition tracking unit 32, a method for executing the face tracking when the face detection is successful is used, but instead of this, a face tracking method without the face detection may be used.

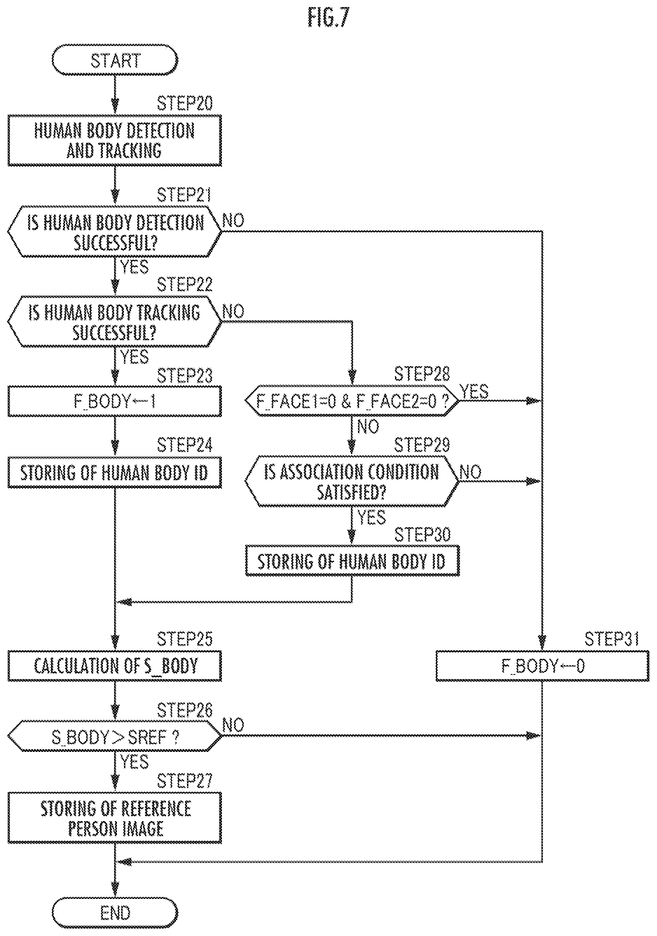

Next, the human body tracking unit 33 will be described. In the human body tracking unit 33, when the rear spatial image signal described above is input from the rear camera 14 to the control device 10, human body tracking processing is executed as illustrated in FIG. 7. In the human body tracking processing, as described below, the human body tracking of the guide target person is executed using the rear spatial image included in the rear spatial image signal.

First, the human body detection and tracking is executed (FIG. 7/STEP20). In this human body detection and tracking, first, human body detection is executed. Specifically, for example, an image of a human body is detected in the rear spatial image 50 as illustrated in FIG. 6. In this case, the human body detection in the rear spatial image 50 is executed using the predetermined image recognition method (for example, an image recognition method using the CNN). When the human body detection is successful, a provisional human both ID is assigned to a human body bounding box 52 as illustrated in FIG. 6.

Following this human body detection, human body tracking of the guide target person is executed. In this case, for example, the human body tracking is executed based on a relationship between a position of the human body bounding box 52 at previous detection and a position of the human body bounding box 52 at current detection, and when the relationship between both positions is in a predetermined state, it is recognized that the human body tracking of the guide target person is successful. Then, when the human body tracking of the guide target person is successful, the provisional human body ID is abandoned, and the human body ID of the guide target person stored in the human body tracking unit 33 is set as the current human body ID of the guide target person. That is, the human body ID of the guide target person is maintained.

Next, it is determined whether the human body detection is successful (FIG. 7/STEP21). When the determination is negative (STEP21 . . . NO) and the human body detection fails, a human body tracking flag F_BODY is set to “0” to represent that the human body tracking fails (FIG. 7/STEP31). Thereafter, this processing ends.

On the other hand, when the determination is affirmative (STEP21 . . . YES) and the human body detection is successful, it is determined whether the human body tracking of the guide target person is successful (FIG. 7/STEP22). When the determination is affirmative (FIG. 7/STEP22 . . . YES) and the human body tracking of the guide target person is successful, the human body tracking flag F_BODY is set to “1” to represent the success (FIG. 7/STEP23).

Next, processing of storing the human body ID is executed (FIG. 7/STEP25). Specifically, the human body ID of the guide target person maintained in the above human body detection and tracking is stored in the human body tracking unit 33 as the human body ID of the guide target person.

Next, a degree of difference S_BODY of the image of the human body is calculated (FIG. 7/STEP25). The degree of difference S_BODY represents the degree of difference between the current human body image and one or more reference person images stored in the reference person image storage unit 34. In this case, when the reference person image is not stored in the reference person image storage unit 34, the degree of difference S_BODY is set to a value larger than a predetermined value SREF to be described later.

Next, it is determined whether the degree of difference S_BODY is larger than the predetermined value SREF (FIG. 7/STEP26). This predetermined value is set to a predetermined positive value. When the determination is negative (FIG. 7/STEP26 . . . NO), the processing ends as it is.

On the other hand, when the determination is affirmative (FIG. 7/STEP26 . . . YES) and S_BODY>SREF is satisfied, the current human body image is stored as the reference person image in the reference person image storage unit 34 (FIG. 7/STEP27). In this case, the feature amount of a current human body image may be stored in the reference person image storage unit 34 as the feature amount of the reference person image. Thereafter, this processing ends.

As described above, in the human body tracking processing, every time the human body tracking of the guide target person is successful and S_BODY>SREF is satisfied, the human body image in the human body bounding box 52 is additionally stored as the reference person image in the reference person image storage unit 34.

On the other hand, when the determination is negative (FIG. 7/STEP22 . . . NO) and the human body tracking of the guide target person fails, it is determined whether both the facial recognition flag F_FACE1 and the face tracking flag F_FACE2 are “0” (FIG. 7/STEP28).

When the determination is affirmative (FIG. 7/STEP28 . . . YES) and both the facial recognition and the face tracking fail, as described above, the human body tracking flag F_BODY is set to “0” (FIG. 7/STEP31). Thereafter, this processing ends.

On the other hand, when the determination is negative (FIG. 7/STEP28 . . . NO) and the facial recognition or the face tracking is successful, it is determined whether association condition is satisfied (FIG. 7/STEP29). This association condition is an execution condition of association between the provisional human body ID described above and the face ID of the guide target person in a case where the facial recognition or the face tracking is successful. In this case, when the face bounding box at the time of successful face tracking or facial recognition is it the detected human body bounding box, it is determined that the association condition is satisfied, and otherwise, it is determined that the association condition is not satisfied.

When the determination is negative (FIG. 7/STEP29 . . . NO) and the association condition is not satisfied, the human body tracking flag F_BODY is set to “0” as described above (FIG. 7/STEP31). Thereafter, this processing ends.

On the other hand, when the determination is affirmative (FIG. 7/STEP29 . . . YES) and the association condition is satisfied, the provisional human body ID set at the time of human body detection is stored, in the human body tracking unit 33, as the current human body ID of the guide target person in a state of being linked to the face ID in face tracking or facial recognition (FIG. 7/STEP30).

Next, as described above, the degree of difference S_BODY of the human body image is calculated (FIG. 7/STEP25), and it is determined whether the degree of difference S_BODY is larger than the predetermined value SREF (FIG. 7/STEP26). Then, when S_BODY>SREF is satisfied, the current human body image is stored as the reference person image in the reference person image storage unit 34 (FIG. 7/STEP27). Thereafter, this processing ends. On the other hand, when S_BODY≤SREF is satisfied, this processing ends as it is.

As described above, in the human body tracking unit 33, the human body tracking of the guide target person is executed, whereby a value of the human body tracking flag F_BODY is set. Then, the human body tracking flag F_BODY is output from the human body tracking unit 33 to the determination unit 36.

In addition, in the case of the human body tracking unit 33, the method for executing the human body tracking when the human body detection is successful is used, but instead of this, a human body tracking method without the human body detection may be used.

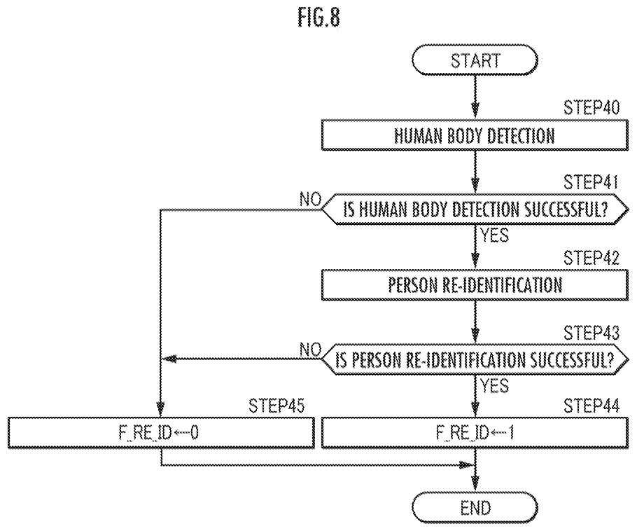

Next, the person re-identification unit 35 will be described. When the rear spatial image signal described above is input from the rear camera 14 to the control device 10, the person re-identification unit 35 executes person re-identification processing as illustrated in FIG. 8. As described below, the person re-identification processing executes person re-identification of the guide target person using the rear spatial image included in the rear spatial image signal.

As illustrated in FIG. 8, first, as described above, the human body detection processing is executed (FIG. 8/STEP40). Next, it is determined whether the human body detection is successful (FIG. 8/STEP41). When the determination is negative (FIG. 8/STEP41 . . . NO) and the human body detection fails, it is determined that the person re-identification fails, and a person re-identification flag F_RE_ID is set to “0” in order to represent the failure (FIG. 8/STEP45). Thereafter, this processing ends.

On the other hand, when the determination is affirmative (FIG. 8/STEP41 . . . YES) and the human body detection is successful, the person re-identification processing is executed (FIG. 8/STEP42).

In this person re-identification processing, the feature amount of the human body image in the rear spatial image is calculated using the CNN, and the degree of similarity between this feature amount and the feature amount of the reference person image stored in the reference person image storage unit 34 is calculated. Then, when the degree of similarity between both feature amounts is a predetermined value or larger, it is determined that the reference person image and the human body image in the rear spatial image are identical, and otherwise, it is determined that the two images are not identical. Note that, in the following description, the determination that the reference person image and the human body image in the rear spatial image are identical is referred to as “successful person re-identification”.

Next, it is determined whether the person re-identification is successful (FIG. 8/STEP43). When the determination is negative (FIG. 8/STEP43 . . . NO) and the person re-identification fails, the person re-identification flag F_RE_ID is set to “0” as described above (FIG. 8/STEP45). Thereafter, this processing ends.

On the other hand, when the determination is affirmative (FIG. 8/STEP43 . . . YES) and the person re-identification is successful, the person re-identification flag F_RE_ID is set to “1” to represent the success (FIG. 8/STEP44). Thereafter, this processing ends.

As described above, the person re-identification unit 35 sets a value of the person re-identification flag F_RE_ID by executing the person re-identification of the guide target person. Then, the person re-identification flag F_RE_ID is output from the person re-identification unit 35 to the determination unit 36.

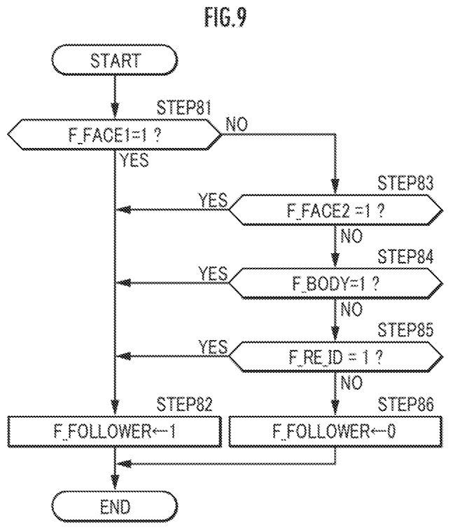

Next, the determination unit 36 will be described. As illustrated in FIG. 9, the determination unit 36 executes result determination processing. As described below, the result determination processing determines whether the recognition of the guide target person is successful according to the values of the above-described four flags F_FACE1, F_FACE2, F_BODY, and F_RE_ID.

As illustrated in FIG. 9, first, it is determined whether the facial recognition flag F_FACE1 is “1” (FIG. 9/STEP81). When the determination is affirmative (FIG. 9/STEP81 . . . YES), that is, when the facial recognition of the guide target person is successful in the current facial recognition processing, a target person flag F_FOLLOWER is set to “1” to represent that the recognition of the guide target person is successful (FIG. 9/STEP82). Thereafter, this processing ends.

On the other hand, when the determination is negative (FIG. 9/STEP81 . . . NO), it is determined whether the face tracking flag F_FACE2 is “1” (FIG. 9/STEP83). When the determination is affirmative (FIG. 9/STEP83 . . . YES), that is, when the face tracking of the guide target person is successful in the current face tracking processing, the target person flag F_FOLLOWER is set to “1” to represent that the recognition of the guide target person is successful, as described above (FIG. 9/STEP82). Thereafter, this processing ends.

On the other hand, when the determination is negative (FIG. 9/STEP83 . . . NO), it is determined whether the human body tracking flag F_BODY is “1” (FIG. 9/STEP84). When the determination is affirmative (FIG. 9/STEP84 . . . YES), that is, when the human body tracking of the guide target person is successful in the current human body tracking processing, the target person flag F_FOLLOWER is set to “1” to represent that the recognition of the guide target person is successful, as described above (FIG. 9/STEP82). Thereafter, this processing ends.

On the other hand, when the determination is negative (FIG. 9/STEP84 . . . NO), it is determined whether the person re-identification flag F_RE_ID is “1” (FIG. 9/STEP85). When the determination is affirmative (FIG. 9/STEP85 . . . YES), that is, when the re-identification of the guide target person is successful in the current person re-identification processing, the target person flag F_FOLLOWER is set to “1” to represent that the recognition of the guided person is successful as described above (FIG. 9/STEP82). Thereafter, this processing ends.

On the other hand, when the determination is negative (FIG. 9/STEP85 . . . NO), the target person flag F_FOLLOWER is set to “0” to represent that the recognition of the guide target person fails (FIG. 9/STEP86). Thereafter, this processing ends.

In the present embodiment, when the number of guide target persons is one, the recognition unit 30 executes the recognition of the guide target person and sets the value of the target person flag F_FOLLOWER as described above. Then, the target person flag F_FOLLOWER is output to the control unit 40. Note that, when there is a plurality of guide target persons, the recognition unit 30 executes the recognition of each of the guide target persons by a method similar to the above.

Furthermore, the present embodiment is an example where the facial recognition tracking processing in FIG. 5, the human body tracking processing in FIG. 7, and the person re-identification processing in FIG. 8 are executed in parallel; however, these types of processing may be executed in series.

Next, the control unit 40 will be described. In the control unit 40, the two actuators 24 and 25 previously described are controlled according to the value of the target person flag F_FOLLOWER, the front spatial image signal from the front camera 11, and the measurement signal of the LIDAR 12. Accordingly, a moving speed and a moving direction of the robot 2 are controlled. For example, when the value of the target person flag F_FOLLOWER changes from “1” to “0” and the recognition of the guide target person fails, the moving speed of the robot 2 is controlled to a low speed side in order to re-recognize the guide target person.

As described above, according to the method for recognizing a guide target person of the present embodiment, the facial recognition tracking unit 32 executes the facial recognition processing and the face tracking processing, the human body tracking unit 33 executes the human body tracking processing, and the person re-identification unit 35 executes the person re-identification processing. Then, when at least one of the facial recognition processing, the face tracking processing, the human body tracking processing, and the person re-identification processing is successful, it is determined that the recognition of the guide target person is successful. Therefore, even when the surrounding environment of the guide target person changes, the success frequency in recognition of the guide target person can be increased. As a result, it is possible to continuously recognize the guide target person longer as compared to conventional methods.

In addition, even in a case where the person re-identification processing fails, when the human body tracking processing is successful and S_BODY>SREF is satisfied, the human body image in the human body bounding box 52 is additionally stored as the reference person image in the reference person image storage unit 34, so that the person re-identification can be executed using the increased reference person image in the next person re-identification processing.

In addition, since S_BODY>SREF is satisfied, among the human body images in the human body bounding box 52, the human body image having a high degree of difference from the reference person image in the reference person image storage unit 34 is additionally stored in the reference person image storage unit 34 as the reference person image, so that the human body re-identification can be executed using the reference person image with a large variety. As described above, the success frequency in person re-identification processing can be further increased.

In addition, when the person re-identification is successful in the person re-identification unit 35, an image in the face bounding box 51 in the human body bounding box 52 may be acquired as a reference face image, and this may be added and stored in the reference face image storage unit 31. With this configuration, one reference face image is added into the reference face image storage unit 31 every time the person re-identification is successful in the person re-identification unit 35. As a result, when the facial recognition processing (STEP3) of the facial recognition tracking unit 32 is executed, the number of the reference face images to be compared with the face images in the face bounding box 51 increases, so that the degree of success in facial recognition can be improved.

Furthermore, in a case where previous face tracking of the guide target person has failed, when the human body re-identification has been successful in previous person re-identification processing, the face tracking may be executed by comparing a feature amount of the face portion of the human body from the successful human body re-identification with the feature amount of the thee image in the rear spatial image. With this configuration, the face tracking can be executed using the successful result from the successful person re-identification, and the success frequency in lace tracking can be increased.

In addition, in a case where the human body detection has failed in previous human body tracking processing, when the person re-identification has been successful in previous person re-identification processing, the human body tracking may be executed by comparing the feature amount of the human body from the successful human body re-identification with the feature amount of the image of the human body in the rear spatial image. With this configuration, the human body tracking can be executed using the successful result from the successful person re-identification, and the success frequency in human both tracking can be increased.

On the other hand, in a ease where the determination in STEP 8 in FIG. 5 is negative and the face tracking fails, when the human body tracking is successful and the association condition is satisfied, the provisional face ID set at the time of face detection may be stored in the facial recognition tracking unit 32 as the current face ID of the guide target person in a state of being linked to the human body ID in human body tracking.

In addition, the embodiment is an example in which the robot 2 is used as a mobile device but the mobile device of the present invention is not limited thereto, and it is only necessary that the mobile device have an imaging device, a recognition device, and a storage device. For example, a vehicle-type robot or a biped walking robot may be used as the mobile device.

Furthermore, the embodiment is an example in which the rear camera 14 is used as an imaging device, but the imaging device of the present invention is not limited thereto, and it is only necessary that the imaging device capture the guide target person following the mobile device.

On the other hand, the embodiment is an example in which the control device 10 is used as a recognition device, but the recognition device of the present invention is not limited thereto, and it is only necessary that the recognition device recognize the guide target person following the mobile device based on a spatial image captured by an imaging device. For example, an electric circuit that executes arithmetic processing may be used as a recognition device.

In addition, the embodiment is an example in which the control device 10 is used as a storage device, but the storage device of the present invention is not limited thereto, and it is only necessary that the storage device store the reference face image and the reference person image. For example, an HDD or the like may be used as a storage device.

### REFERENCE SIGNS LIST

2 robot (mobile device)
10 control device (recognition device, storage device)
14 rear camera (imaging device)
31 reference face image storage unit (first step)
32 facial recognition tracking unit (fourth step)
33 human body tracking unit (fourth step)
34 reference person image storage unit (third step)
35 person re-identification unit (fourth step)
36 determination unit (fifth step)
50 spatial image
51 face bounding box
52 human body bounding box
60 guide target person (recognition target person)
S_BODY degree of difference
SREF predetermined value

What is claimed is:

1. A method for recognizing a recognition target person that follows a mobile device including an imaging device, a recognition device, and a storage device when the mobile device moves, by the recognition device, based on a spatial image captured by the imaging device, the method executed by the recognition device, comprising:
a first step of storing a face image of the recognition target person in the storage device as a reference face image;
a second step of acquiring the spatial image captured by the imaging device;
a third step of storing a reference person image, which is an image for reference of the recognition target person, in the storage device;
a fourth step of executing at least three types of processing among facial recognition processing for recognizing a face of the recognition target person in the spatial image based on the reference face image and the spatial image, face tracking processing for tracking the face of the recognition target person based on the spatial image, human body tracking processing for tracking a human body of the recognition target person based on the spatial image, and person re-identification processing for recognizing the recognition target person in the spatial image based on the spatial image and the reference person image; and
a fifth step of determining that the recognition of the recognition target person is successful in a case where at least one of the at least the three types of processing executed in the fourth step is successful.

2. The method for recognizing a recognition target person according to claim 1, wherein
in the execution of the fourth step, when all of the facial recognition processing, the face tracking processing, and the human body tracking processing fail and the person re-identification processing is successful, at least one of next facial recognition processing, face tracking processing, and human body tracking processing is executed using the successful result of the person re-identification processing, and
in the execution of the fourth step, when the person re-identification processing fails and the human body tracking processing is successful, next person re-identification processing is executed using the successful result of the human body tracking processing.

3. The method for recognizing a recognition target person according to claim 1, wherein
in the third step, an image of a human body in the case of the successful human body tracking processing is compared with the reference person image stored in the storage device, and in a case where a degree of difference between the image of the human body and the reference person image is larger than a predetermined value, the image of the human body is additionally stored in the storage device as another reference person image.

4. The method for recognizing a recognition target person according to claim 2, wherein
in the third step, an image of a human body in the case of the successful human body tracking processing is compared with the reference person image stored in the storage device, and in a case where a degree of difference between the image of the human body and the reference person image is larger than a predetermined value, the image of the human body is additionally stored in the storage device as another reference person image.
